(19) United States
(12) Patent Application Publication
(10) Pub. No.: US 2006/0066877 A1
(43) Pub. Date: Mar. 30, 2006

(54) Capture and display of image of three-dimensional object

(76) Inventor: Daniel Benzano, Ramat Gan (IL)

Correspondence Address: DR. MARK FRIEDMAN LTD.;C/o Bill Polkinghorn, 9003 Florin Way, Upper Marlboro, MD, 20772, US

(21) Appl. No.: 11/239,135

(22) Filed: Sep. 30, 2005

Related U.S. Application Data
(60) Provisional application No. 60/614,048, filed on Sep. 30, 2004.

(30) Foreign Application Priority Data
Jan. 30, 2005 (IL) 166574

(51) Int. Cl. G01B 11/24

(52) U.S. Cl. 356/603

(57) ABSTRACT

A system and method for modeling three-dimensional objects such as diamonds and other gemstones. A three-dimensional finite-element model obtained by, for example, analysis of boundaries of the object in photographs taken from multiple perspectives with frontal lighting or silhouette lighting, or by analysis of structured-light photographs of the object taken from multiple perspectives, is combined with color or grayscale information obtained from photographs of the object. Enhanced or “false” color can be used to improve the viewing experience or to emphasize particular features of the object. A computer can rotate the model about arbitrary axes according to the desires of a viewer.

This is a continuation-in-part of U.S. Provisional Patent Application No. 60/614,048, filed Sep. 30, 2004 and claims priority of Israel Patent Application No. 166574 filed Jan. 30, 2005.

### FIELD AND BACKGROUND OF THE INVENTION

The present invention relates to a system and method for capturing and displaying an image of a three-dimensional object, and, more particularly, to a system and method wherein a three-dimensional finite-element model of the outer surface of the object is combined with photographs of the object taken from multiple angles and displayed on a display device such as a computer screen. The photographic data are used to assign color or grayscale values to the elements of the three-dimensional model. The object is then displayed using a combination of the information from the three-dimensional model and the color or grayscale values, providing a realistic view of the object, including any surface markings. The three-dimensional model can be rotated about any axis to provide the user with an experience very similar to examining the object while holding the object in one's hands.

Such a system is particularly desirable for the display of uncut, or rough, precious stones, where it is desirable to determine whether a particular rough stone can be cut to a particular shape.

Such a system is also desirable for such activities as virtually displaying a precious stone to a potential purchaser, in that realistic display of the stone is provided without the risks, such as loss or theft, involved in transporting and displaying a precious stone.

Rough precious stones are often marked with markings that serve as aids and guides to help both in deciding how the stone is to be cut, and in the actual cutting and shaping of the stone. The system of the present invention allows such markings to be seen as part of the virtual image of the stone, which is highly advantageous in the analysis of the stone, and in presenting and explaining possible final shapes for the stone, especially to persons with limited expertise in the field of precious stones.

Various attempts have been made to capture and display images of three-dimensional objects such as precious stones. U.S. Pat. No. 6,567,156 describes the combination of silhouette images and structured light triangulation to produce a three-dimensional map of the surface of an object, including recesses on the surface of the object. However, the map provided according to U.S. Pat. No. 6,567,156 does not provide information to a viewer regarding the color or reflectivity of the surface of the object, nor is there a provision for viewing of the mapped object from arbitrary angles.

There is thus a widely recognized need for, and it would be highly advantageous to have, a system and method for capturing a three-dimensional image of the surface of an object, such as a precious stone, including the reflectivity and/or color of the surface of the object, and displaying the three-dimensional image as a grayscale or color image that can be rotated by the viewer about arbitrary axes.

### SUMMARY OF THE INVENTION

In a system according to the present invention, a three-dimensional finite-element model of an object and photographs of the object are combined into an enhanced three-dimensional finite-element model that includes color and/or reflectivity information for the elements of the model. To a viewer, the effect is as if the photographs had been pasted onto the three-dimensional finite-element model. Such an enhanced model of the object provides a very realistic viewing experience.

According to the present invention there is provided a modeling system including: (a) a modeling mechanism operative to create a geometric model of at least a portion of an object; (b) an imaging mechanism operative to obtain at least one reflectivity image of the object, and (c) a mapping mechanism operative to map at least a portion of a the reflectivity image to at least a portion of the geometric model so as to provide a reflectivity model of at least a portion of the object.

Preferably, in the system, the imaging mechanism is operative to obtain a plurality of images taken from a plurality of perspectives.

Preferably, in the system, the perspectives include angles disposed about an axis.

Preferably, the system further includes: (d) a holder operative to hold and rotate the object, and the perspectives are obtained by rotation of the object by the holder.

Preferably, in the system, the holder includes a vacuum mechanism operative to secure the object to the holder.

Preferably, in the system, the object includes a diffusing coating.

Optionally, in the system, the object includes at least one mark.

Preferably, in the system, the object includes a gemstone.

Preferably, in the system, the object includes a component selected from the group consisting of a diamond, an emerald and a ruby.

Preferably, the system further includes: (d) an enclosure operative to isolate at least one component of the modeling system, selected from the group consisting of the modeling mechanism and the imaging mechanism, from stray light.

Preferably, in the system, the modeling mechanism includes a camera.

Preferably, in the system, the camera includes a digital camera.

Preferably, in the system, the modeling mechanism includes a source of structured light.

Preferably, in the system, the source of structured light is operative to produce a beam having a substantially linear cross-section.

Preferably, in the system, the source of structured light includes a laser.

Alternatively, in the system, the modeling mechanism is operative to create the geometric model from a plurality of boundaries of the object, the boundaries being obtained from a plurality of images of the object.

Preferably, in the system, at least one image from which a corresponding boundary is obtained is a silhouette image of the object.

Alternatively, in the system, at least one image from which a corresponding boundary is obtained is a reflectivity image of the object.

Preferably, in the system, the imaging mechanism includes a camera.

Preferably, in the system the camera includes a digital camera.

Preferably, in the system, the imaging system includes a light source.

Preferably, in the system, the light source includes a light-emitting element selected from the group consisting of a light-emitting diode, a discharge lamp, a fluorescent lamp, an electroluminescent light, a laser and an incandescent lamp.

Preferably, in the system, the geometric model includes information from a structured-light image and information from an image selected from the group consisting of a reflectivity image and a silhouette image.

Preferably, in the system, the geometric model includes a three-dimensional finite-element model.

Preferably, the system further includes: (d) a display device operative to show reflectivity of at least a portion of a surface of the object.

Preferably, in the system, the reflectivity model includes reflectivity information selected from the group consisting of grayscale information, color information, and enhanced color information.

Preferably, in the system, the modeling system is operative to rotate the reflectivity model through an arbitrary angle about an arbitrary axis.

According to the present invention there is provided a modeling method including the steps of: (a) obtaining a geometric model of at least a portion of a surface of an object; (b) obtaining at least one reflectivity image of the object, and (c) combining the geometric model and reflectivity data from the reflectivity image to obtain a reflectivity model of at least a portion of the object.

Preferably, in the method, a plurality of the reflectivity images is obtained from a plurality of perspectives.

Preferably, the method further includes the step of: (d) rotating the object to obtain the plurality of perspectives.

Preferably, the method further includes the step of: (d) applying a diffusing coating to the object.

Optionally, the method further includes the step of: (d) marking the object.

Preferably, in the method, the object includes a gemstone.

Preferably, in the method, the object includes a component selected from the group consisting of a diamond, an emerald and a ruby.

Preferably, in the method, the modeling is effected by steps including illuminating the object with structured light.

Preferably, in the method, the structured light includes a beam having a substantially linear cross-section.

Alternatively, in the method, the obtaining of the geometric model includes: (i) obtaining images of the object from at least two perspectives; (ii) extracting boundaries from the images, and (iii) creating the geometric model from the boundaries.

Preferably, in the method, at least one image is a silhouette image of the object.

Alternatively, in the method, at least one image is a reflectivity image of the object.

Preferably, the method further includes the step of: (d) illuminating the object with a light source selected from the group consisting of a light emitting diode, a discharge lamp, a fluorescent lamp, an electroluminescent light, a laser and an incandescent lamp.

Preferably, in the method, the obtaining of the geometric model includes obtaining at least one structured-light image of the object and at least one image, of the object, selected from the group consisting of a reflectivity image and a silhouette image, the geometric model being based on the images.

Preferably, in the method, the geometric model includes a three-dimensional finite-element model.

Preferably, the method further includes the step of: (d) displaying reflectivity of at least a portion of a surface of the object.

Preferably, in the method, the reflectivity model includes reflectivity information selected from the group consisting of grayscale information, color information, and enhanced color information.

Preferably, the method further includes the step of: (d) rotating the reflectivity model through an arbitrary angle about an arbitrary axis.

According to the present invention there is provided a machine readable storage medium having stored thereon machine executable instructions, the execution of the machine executable instructions implementing a method for modeling, the method including the steps of: (a) obtaining a geometric model of at least a portion of a surface of an object; (b) obtaining at least one reflectivity image of the object, and (c) combining the geometric model and reflectivity data from the reflectivity image to obtain a reflectivity model of at least a portion of the object.

Preferably, in the machine readable storage medium, the object includes a gemstone.

Preferably, in the machine readable storage medium, the object includes a component selected from the group consisting of a diamond, an emerald and a ruby.

### BRIEF DESCRIPTION OF THE DRAWINGS

The invention is herein described, by way of example only, with reference to the accompanying drawings, wherein:

FIG. 1a illustrates schematically a plan view of a system for image capture according to the present invention;

FIG. 1b illustrates schematically a plan view of an alternative system for image capture according to the present invention, incorporating a source of structured light;

FIG. 1c illustrates schematically a plan view of an alternative system for image capture according to the present invention, incorporating a source of silhouette lighting;

FIG. 2 illustrates schematically a three-dimensional coordinate system for an object;

FIG. 3 illustrates schematically a two-dimensional coordinate system for a photograph of an object;

FIG. 4a is a photographic image of an object taken with an apparatus according to the present invention;

FIG. 4b is a photographic image of the object depicted in FIG. 4a, after rotation, taken with an apparatus according to the present invention;

FIG. 5a is a photographic image of the object depicted in FIG. 4a, in the same position as in FIG. 4a, illuminated with a source of structured light;

FIG. 5b is a photographic image of the object depicted in FIG. 4a, in the same position as in FIG. 4b, illuminated with a source of structured light;

FIG. 6a is a photographic image of the object depicted in FIG. 4a, in the same position as in FIG. 4a, illuminated from behind to produce a silhouette image;

FIG. 6b is a photographic image of the object depicted in FIG. 4a, in the same position as in FIG. 4b, illuminated from behind to produce a silhouette image;

FIG. 7a illustrates schematically an elevation view of a system for structured lighting of an object;

FIG. 7b illustrates schematically a plan view of the system of FIG. 7a for structured lighting of an object

FIG. 8a illustrates schematically an elevation view of a system according to the present invention wherein the optical axis of the camera is substantially perpendicular to the axis of rotation of an object;

FIG. 8b illustrates schematically an elevation view of a system according to the present invention wherein the optical axis of the camera forms an acute angle with the axis of rotation of an object;

FIG. 9 illustrates schematically a system according to the present invention including a computer and a storage medium containing instructions operative to control the operation of the system.

### DESCRIPTION OF THE PREFERRED EMBODIMENTS

The present invention is of a system and method which can be used to capture and display images of a three-dimensional object so that a user is presented with an image that shows the reflectivity and/or color of the surface of the object, and so that the user can select to view the object as if rotated arbitrarily in space.

The principles and operation of a system for capturing and displaying images of a three-dimensional object according to the present invention may be better understood with reference to the drawings and the accompanying description.

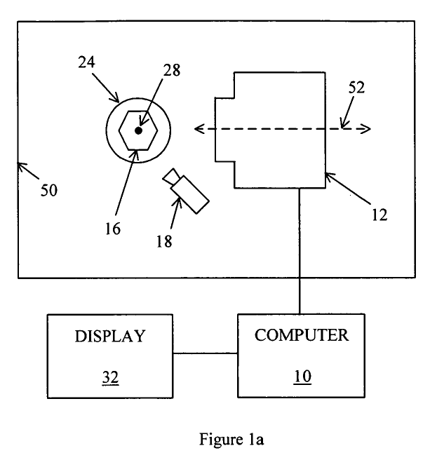

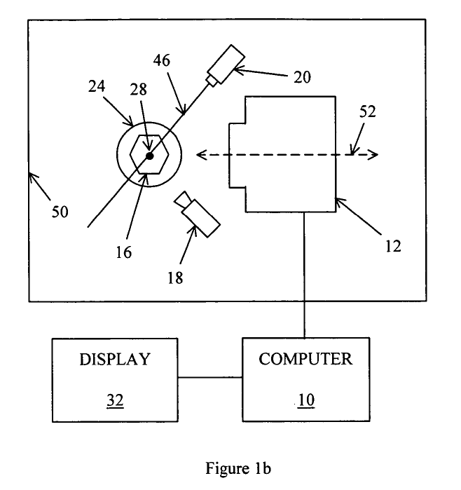

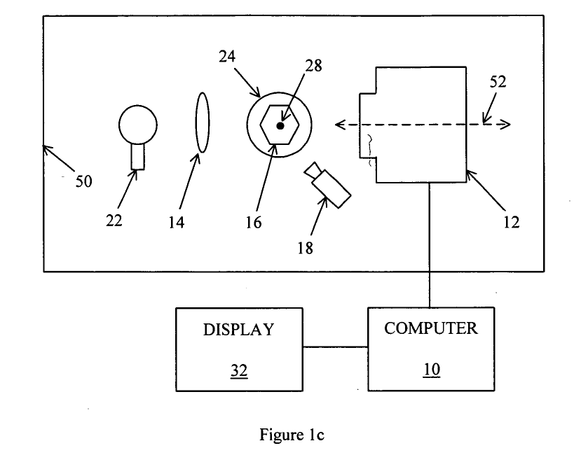

Referring now to the drawings, FIG. 1a illustrates schematically a first embodiment of the present invention, in which an object 16 is held on a rotatable support, or dop, 24. Optionally, object 16 is coated with a preferably removable coating that diffuses light. Coating object 16 is particularly advantageous if object 16 is transparent and/or reflective. Marks can be made on the coating. If the coating is sufficiently thin and made of appropriate material, surface marks on object 16 will be visible through the coating. Preferably, object 16 is held onto dop 24 by a vacuum mechanism. An enclosure 50 is operative to suppress stray light.

Object 16 is illuminated by a lamp 18 and photographed by a camera 12, and then rotated through an angle by dop 24, the angle preferably having measure of at least 0.1 degree and no greater than 20 degrees, and, still more preferably, having measure of at least 0.5 degree and no greater than 5 degrees, the angle also preferably having measure substantially equal to a full circle divided by an integer, before being photographed again. Although rotation of object 16 through substantially uniform angles meeting the above criteria between consecutive photographings of object 16 is preferred because it simplifies mathematical manipulation of the images, the use of non-uniform angles and/or an angle not meeting the above criteria is within the scope of the present invention. This procedure is repeated until object 16 has been rotated through substantially a full rotation, and a set of reflectivity photographs including information about the reflectivity of the surface of object 16 as viewed from multiple angles is obtained.

Lamp 18 illuminates object 16 frontally, so that reflectivity photographs produced during the rotation of object 16 include information about the reflectivity and/or color of the surface regions of object 16. Lamp 18 may include, but is not limited to, a light-emitting diode, a discharge lamp, a fluorescent lamp, an electroluminescent light, a laser or an incandescent lamp.

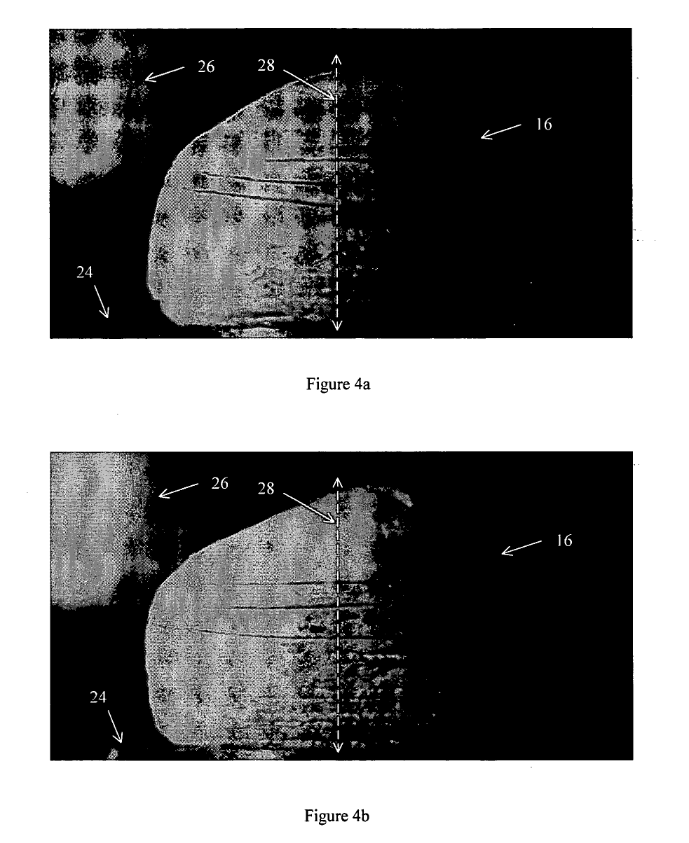

Examples of such reflectivity photographs are shown in FIGS. 4a and 4b, wherein object 16 rests upon dop 24, dop 24 being operative to rotate object 16 about an axis 28. A reflection 26 of lamp 18 is an artifact of the prototype system used to produce FIGS. 4a and 4b, and such artifacts can be suppressed by appropriate design of enclosure 50 and use of low-reflectivity materials, or image-processing software can effectively eliminate or compensate for such artifacts.

Preferably, camera 12 in FIG. 1a is a solid-state camera, such as a charge-coupled device (CCD) camera, although other types of cameras may be used, and the use of any type of camera 12 is within the scope of the present invention. Preferably, camera 12 is a digital camera connected to a modeling mechanism such as a computer 10. Computer 10 is not necessarily limited to this role in the system of the present invention, and can also perform other functions in the system, as indicated below. Through image-processing techniques well-known in the art, such as, for example, threshholding, a boundary of object 16 is determined for each of the reflectivity photographs. The boundaries thus determined are then used to create a three-dimensional finite-element model of the surface of object 16 using techniques well-known in the art, as used, for example, in the OGI-Rough System, OGI Systems, Ltd., Ramat Gan, Israel.

The reflectivity measurements included in the reflectivity photographs are then mapped onto the three-dimensional model. Preferably, this mapping is performed by a mapping mechanism, such as computer 10. This mapping assigns a reflectivity value to each element of the three-dimensional finite-element model. The reflectivity information can be monochrome, or can include information indicating color. The three-dimensional finite-element model, enhanced with reflectivity information, thus produced provides the information needed to display, using systems and methods well-know in the art, as used, for example, in the aforementioned OGI-Rough System, a realistic image of object 16 on a display device 32, and this image can rotated by the user about arbitrary axes. Such systems and methods can provide for grayscale and/or color display, including, optionally, enhanced, or “false”, color. Preferably, the finite-element three-dimensional model includes a fine-mesh model of the surface of object 16. The elements of the three-dimensional model can be of arbitrary shape and can include triangles and quadrilateral figures. Preferably, the elements are triangular, although elements of any shape are within the scope of the present invention. Preferably, the reflectivity value assigned to any particular triangular element is an average of the reflectivity values determined for the three vertices of the triangle. Alternatively, reflectivity values can be determined by other functions, including, but not limited to, the reflectivity value of a single, arbitrarily selected point on the surface of the triangle, or a weighted average of a collection of points on or near the surface of the triangle. Such alternative determinations of reflectivity values are included within the scope of the present invention. Reflectivity values for elements having other shapes can be determined by similar mechanisms adapted to those shapes, and such mechanisms are included within the scope of the present invention.

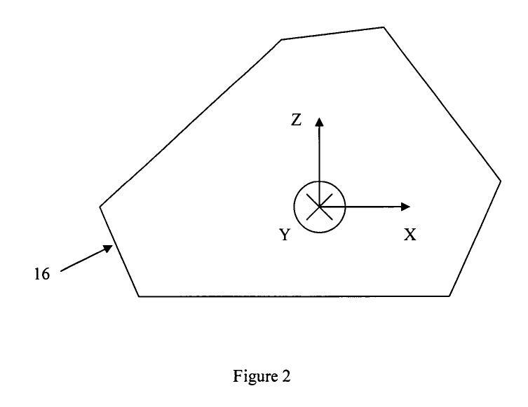

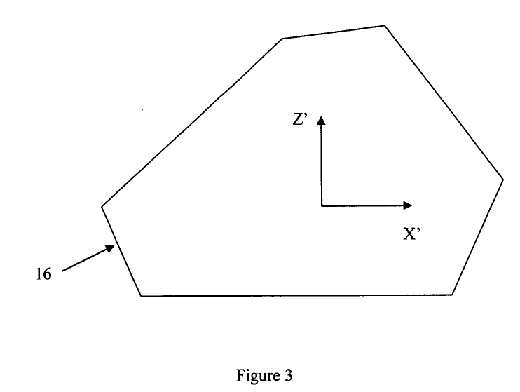

FIG. 2 illustrates schematically a coordinate system for object 16, applicable to this embodiment. The coordinate system of FIG. 2 is fixed to object 16, and thus rotates along with object 16 as object 16 is rotated. The Z-axis of the coordinate system of FIG. 2 corresponds to the axis of rotation of dop 24. FIG. 3 illustrates schematically a coordinate system for the P^{th} two-dimensional reflectivity photograph of object 16, where P is an index into a set of N_{c} two-dimensional reflectivity photographs of object 16. The N_{c} photographs are taken with object 16 rotated through an angle substantially equal to 360°/N_{c} between the taking of successive photographs. The coordinate system of FIG. 3 remains fixed relative to camera 12 as object 16 is rotated. Taking into account the relative rotation of the respective coordinate systems of FIG. 2 and FIG. 3, the mapping from a three-dimensional point (X, Y, Z) on object 16 in the coordinate system of FIG. 2 to a point (X′_{P}, Z′_{P}) on the P^{th} two-dimensional reflectivity photograph from a total of N_{c} two-dimensional reflectivity photographs is according to the formulae:
X′_{P}=X cos α−Y sin α (1)
and
Z′_{P}=Z (2)
where
α=2πP/N_{c}

This embodiment has the advantage of requiring only a single set of photographs to both capture reflectivity information and produce a three-dimensional finite-element model of object 16. Some other embodiments, some of which are discussed below, require a second set of photographs to produce a three-dimensional finite-element model of object 16. Although determination of boundaries of object 16 from reflectivity photographs can be computation-intensive and subject to error, the elimination of the need for a second set of photographs has several compensatory advantages. Rotating object 16 takes time. Although it is possible, if camera 12 is sufficiently fast, for camera 12 to photograph object 16 while object 16 is rotating, it is preferable, in order for the photographs to be as clear as possible, for object 16 to be stopped, relative to camera 12, at the time that object 16 is photographed by camera 12. The time required to rotate object 16 for a second set of photographs, including the time required for object 16 to settle at each step of the rotation, can be more than the extra time required by computer 10 to determine the boundaries of object 16 from reflectivity photographs relative to the time required by computer 10 to determine the boundaries of object 16 by other techniques. Although, in the embodiments discussed below which require two sets of photographs of object 16, it is possible to produce both sets with a single rotation of object 16, the two different types of photographs require different lighting of object 16, as discussed below. This requires changing the lighting of object 16 at every step of the rotation. Thus, if the light sources involved require time to stabilize after being turned on, or if the light sources exhibit afterglow after being turned off, the time required to photograph object 16 is correspondingly increased, the increase being proportional to the number of rotational steps. Being repeatedly turned on and off can cause rapid wear of some light sources, notably incandescent lamps. This embodiment also reduces the memory requirement of the system, because only one set of photographs need be stored.

Alternatively, only a half-rotation of object 16 is necessary to provide the information about the boundaries of object 16 necessary to construct a three-dimensional model of object 16. This is because rotation of object 16 by a half-rotation about axis 28 simply reflects the positions of boundary points of object 16 about axis 28, without providing any new boundary information about object 16. Thus, if photographs corresponding to a full rotation of object 16 were to be used for constructing a three-dimensional model of object 16, a photograph taken during the second half-rotation of object 16 would include substantially the same information about the boundaries of object 16 as would be included in a photograph of object 16 taken a half-rotation earlier during the first half-rotation of object 16. Therefore, the three-dimensional model can be determined using reflectivity photographs corresponding to only a half-rotation of object 16. However, rotation of object 16 by a half-rotation about axis 28 does present new reflectivity information to camera 12, and it is thus desirable to make use of reflectivity photographs corresponding to a substantially full rotation of object 16 about axis 28.

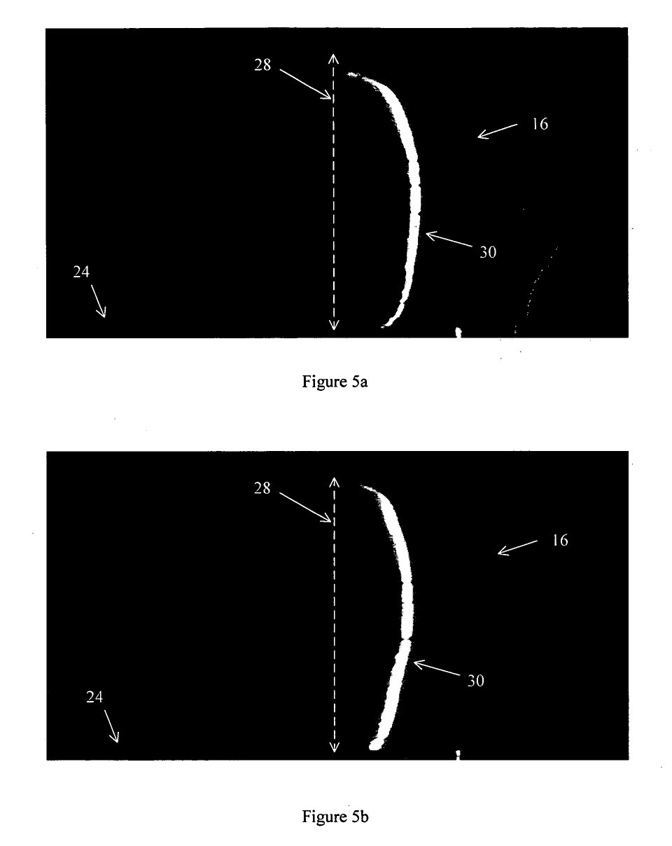

A second, alternative, embodiment of the present invention, illustrated schematically in FIG. 1b, is substantially similar to the above-described first embodiment, except that information for producing a three-dimensional model of object 16 is obtained from an additional set of photographs in which object 16 is illuminated by a source of structured light. In this embodiment, a structured light source 20, such as a shaped laser beam, discussed more fully below, illuminates object 16 with structured light, preferably in the form of a vertical stripe of light, in a manner that permits a three-dimensional model of object 16 to be extracted from an additional set of photographs of object 16 taken by camera 12 while object 16 is illuminated with structured light and rotated between successive photographings in a manner as described above for the reflectivity photographs. For example, as seen in FIGS. 5a and 5b, which are examples of such structured-light photographs, a narrow vertical stripe of light projected onto object 16 from a structured-light source 20 located off optical axis 52 of camera 12 will produce narrow bright regions 30 (FIGS. 5a and 5b) in photographs taken by camera 12. Triangulation of points of regions 30 provides information for constructing a three-dimensional model of object 16. A three-dimensional model constructed in this manner can reveal recesses in the surface of object 16. The high-contrast images obtained with structured lighting ease the computational burden of determining the three-dimensional model. Because each structured-light photograph according to this embodiment only provides information about one side of object 16, a substantially full rotation of object 16 is required to produce a complete three-dimensional model of the surface of object 16, rather than a half rotation, which is sufficient for the above-described first embodiment, wherein each reflectivity photograph provides information about two sides of object 16.

Alternatively, in this second embodiment, object 16 can be rotated a single time, with lamp 18 and structured light source 20 illuminated by turns such that camera 12 produces an interleaved set of photographs including both the information for creating the three-dimensional model and the reflectivity data.

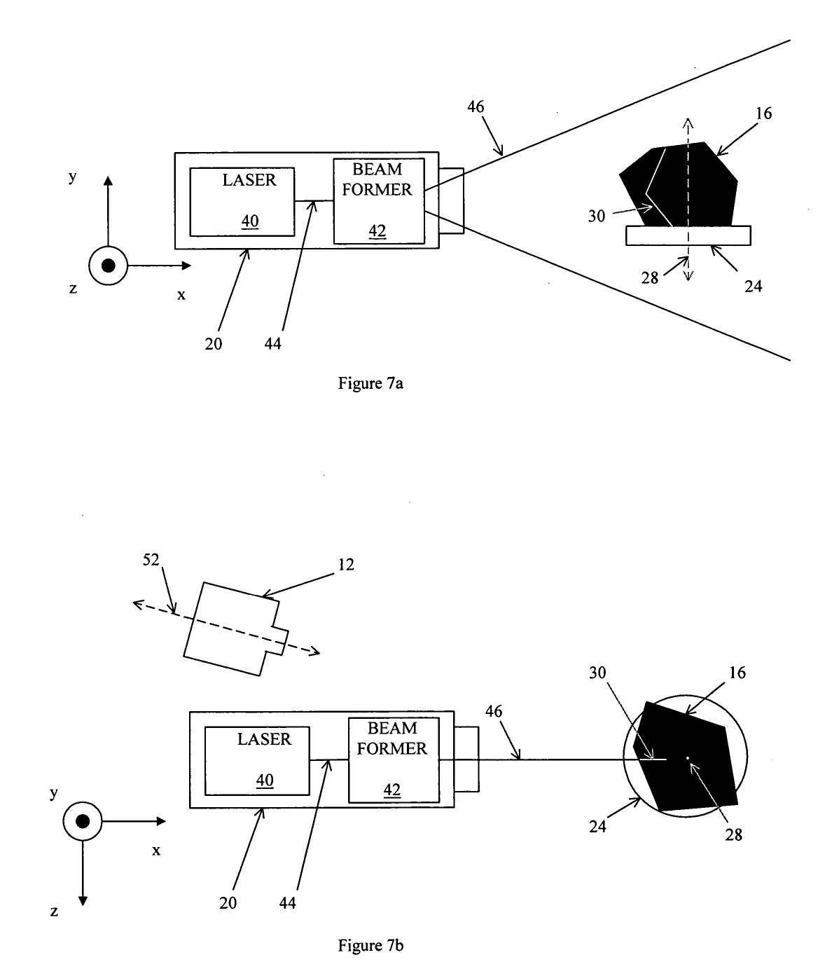

Returning now to structured light source 20, FIG. 7a illustrates schematically an elevation view, and FIG. 7b illustrates schematically a plan view, of a system for structured lighting of object 16. For simplicity, camera 12 is not shown in FIG. 7a. Structured-light source 20 is operative to illuminate object 16 with structured light. Preferably, structured-light source 20 includes a laser 40, operative to produce a beam of light 44, and an optical system 42 operative to shape beam 44 into a structured beam 46. Preferably, structured beam 46 has a very narrow cross-section, preferably no greater than 20 μm, in the neighborhood of object 16, in a first dimension normal to a direction of propagation of structured beam 46, and a rather wide cross section, preferably at least spanning object 16 in the neighborhood of object 16, in a second dimension normal to both the first dimension and a direction of propagation of structured beam 46. Thus, structured beam 46 has a substantially linear cross-section. Preferably, the second dimension is substantially parallel to axis of rotation 28. When illuminated only by such a structured beam 46, object 16 will appear to be dark except for a bright stripe 30. Because structured beam 46 propagates in a direction that is offset from optical axis 52 of camera 12, bright stripe 30 appears to camera 12 not as a straight line segment, but rather as a shape that is a function of the three-dimensional shape of object 16. Such a structured beam 46 can be produced by a variety of systems and methods well-know to those skilled in the art, including, but not limited to, lenses, curved mirrors, oscillating mirrors, rotating mirrors, and diffraction slits.

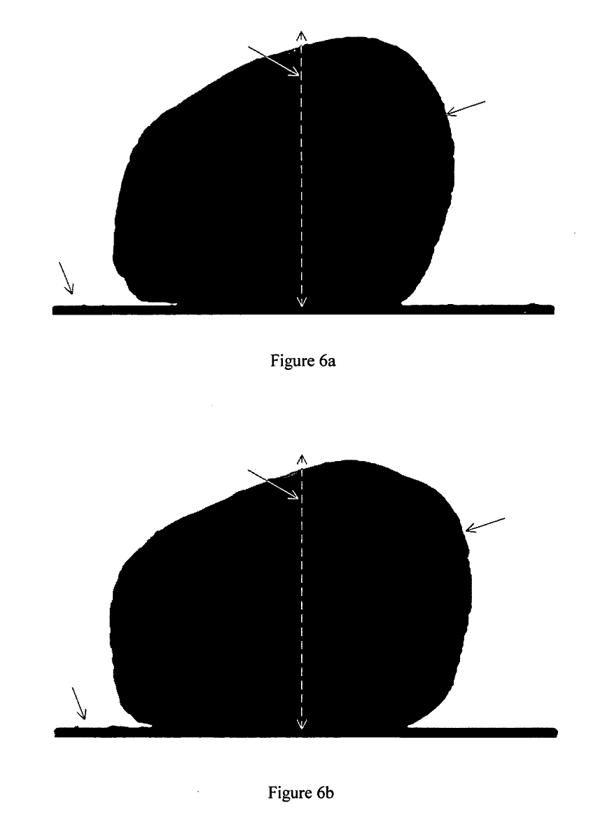

A third, alternative, embodiment of the present invention, illustrated schematically in FIG. 1c, is substantially similar to the above-described first embodiment, except that information for producing a three-dimensional model of object 16 is obtained from an additional set of photographs in which object 16 is illuminated from behind so as to produce a set of silhouette photographs. FIGS. 6a and 6b show examples of such silhouette photographs. In this embodiment a light source 22 is operative, preferably via a condensing lens 14, to illuminate object 16 from behind such that camera 12 views object 16 in silhouette. Object 16 is rotated between successive photographings in a manner as described above for the reflectivity photographs. The silhouette photographs thus produced are then used to create a three-dimensional model of object 16.

In a manner similar to the above-described first embodiment, only a half-rotation of object 16 is necessary to provide silhouette photographs including information about boundaries of object 16 necessary to construct a three-dimensional model of object 16.

In a manner similar to the above-described second (i.e., structured-light) embodiment, the high-contrast nature of the silhouette photographs eases the computational burden of producing a three-dimensional model.

Alternatively, in this third embodiment, object 16 can be rotated a single time, with lamp 18 and light source 22 illuminated by turns such that camera 12 produces an interleaved set of photographs including both the information for creating the three-dimensional model and the reflectivity data. In a manner similar to that described above for the first embodiment, silhouette photographs from only a half-rotation of object 16 are necessary to construct a three-dimensional model of the surface of object 16, although it is desirable to use reflectivity photographs corresponding to a substantially full rotation of object 16 to provide reflectivity information about the surface of object 16, because, although rotation of object 16 by a half-rotation about axis 28 does not present new information about the boundaries of object 16 to camera 12, such rotation does present new reflectivity information about the surface of object 16 to camera 12.

Because, in the above-described embodiments, object 16 is rotated through a small angle between the taking of one reflectivity photograph and the next, a point on object 16 is generally visible in more than one reflectivity photograph. Thus, there are many ways to make use of the reflectivity information corresponding to any particular point on object 16. In general, a reflectivity value associated with any particular point on a surface of the three-dimensional model of object 16 is a function of the various representations, as determined by formulae 1 and 2, corresponding to that point in the set of reflectivity photographs of object 16. Preferably, that function is a weighted average of the various points. The weightings for such a weighted average can be selected as desired. For example, equal weighting of corresponding points in several reflectivity photographs can compensate for changes in brightness related to changes in the orientation of a surface relative to lamp 18 and camera 12 as object 16 is rotated about axis 28. Alternatively, in a degenerate form of weighted average, the reflectivity information contained in only a single reflectivity photograph corresponding to a particular point on a surface of object 16 is used for that point, allowing for faster and simpler computation. Preferably, this single reflectivity photograph is the reflectivity photograph wherein the absolute value of the X′ coordinate of the point, as determined by formula 1, is minimized. All selections and weightings of reflectivity information are within the scope of the present invention.

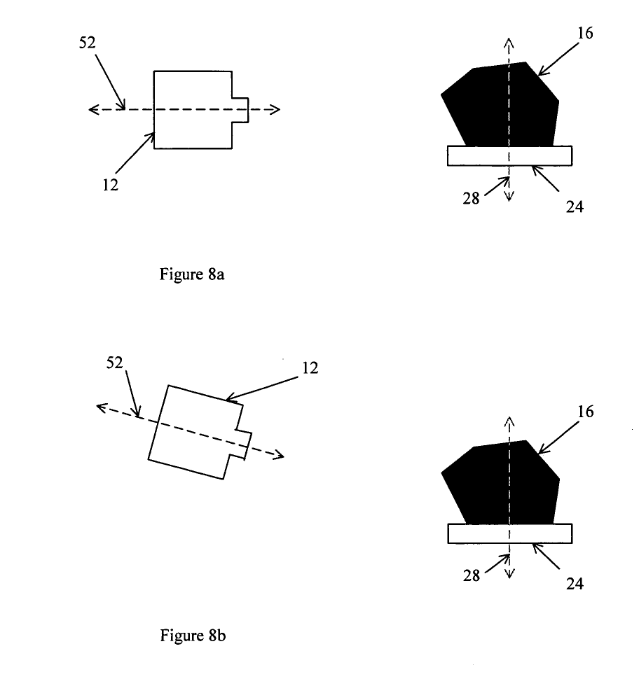

FIG. 8a illustrates schematically an elevation view of a system according to the present invention in which optical axis 52 of camera 12 is substantially perpendicular to axis 28. It is apparent from FIG. 8a that photographs taken by camera 12 of object 16 in such a system do not include a portion of object 16 where object 16 makes contact with dop 24, and that a portion of object 16 opposite dop 24 will also not be adequately represented in the photographs. These portions can be made viewable according to the present invention by performing a second scan of object 16, but with a different portion of object 16 being in contact with dop 24.

Information from two scans of object 16, with different portions of object 16 being in contact with dop 24 during each respective scan, as described above, can be merged into a single model of object 16, thus allowing a user to view a single model of the complete surface of object 16, without any region being missing because of the need to support object 16 on dop 24. This merging can be performed using software operative to recognize pairs of corresponding features in the respective models of object 16 produced during the two scans and to merge the models accordingly.

Selecting an optical axis 52 for camera 12 that is slightly displaced from being perpendicular to axis of rotation 28 of dop 24, as shown schematically in FIG. 8b, can make the portion of object 16 opposite dop 24 visible, at the expense of a slightly larger region of object 16 at the contact with dop 24 not being included in the photographs. Thus, only a single region of object 16 is not visible, rather than two regions. In this variation, the region of object 16 where dop 24 is contacted can also be made visible in a second scan of object 16 with a different portion of object 16 being in contact with dop 24. The two models of object 16 thus made using two scans of object 16 can be combined into a single model, as described above.

It can be desirable to obtain information for a three-dimensional model of object 16 from more than one source, thus improving the quality of the model obtained. For example, the structured-light model is capable of revealing recesses in the surface of object 16, but can sometimes include undesired artifacts in the form of spurious protrusions from the surface. On the other hand, the silhouette model does not include undesired artifacts, but does not reveal recesses in the surface of object 16. Combination of these two models can produce a model that reveals recesses in the surface of object 16 without undesired artifacts. Alternatively, a three-dimensional model based on reflectivity photographs, of object 16, can be combined with the structured-light model to suppress artifacts. The use of combinations of models to produce a three-dimensional model of object 16 is within the scope of the present invention.

The present invention thus provides a mechanism for viewing an image of a three-dimensional object, such as a precious stone, from any desired angle. The image not only shows the geometry of the surface of the object, but also shows the coloration of the surface of the object.

Although particular examples of mechanisms for the obtaining of a three-dimensional finite-element model of an object have been presented herein, the present invention can make use of a three-dimensional finite-element model obtained by any mechanism, and the use of three-dimensional finite-element models obtained by any mechanism is within the scope of the present invention.

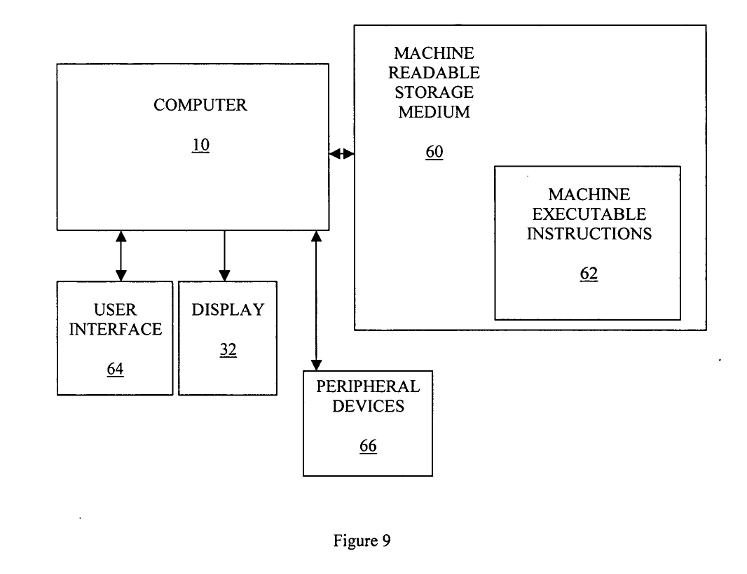

A system according to the present invention can be implemented as illustrated schematically, by way of example only, in FIG. 9. In FIG. 9, for the sake of simplicity, several system components illustrated in more detail in FIGS. 1a-c, etc., such as dop 24, camera 12, light source 18, etc., are represented as “peripheral devices” 66. Computer 10 executes machine executable instructions 62 stored in machine readable storage medium 60. Machine readable instructions 62 are selected, in accordance with that which is taught in the present invention, such that execution of machine readable instructions 62 by computer 10 is operative to manipulate display 32 and peripheral devices 66 in accordance with user commands supplied via user interface 64.

Many alterations and modifications of the system illustrated in FIG. 9 may be made within the scope of the present invention. It is to be understood that the example of FIG. 9 is presented herein by way of illustration only, and is in no way intended to be considered limiting.

While the invention has been described with respect to a limited number of embodiments, it will be appreciated that many variations, modifications and other applications of the invention may be made.

What is claimed is:

1. A modeling system comprising:
(a) a modeling mechanism operative to create a geometric model of at least a portion of an object;
(b) an imaging mechanism operative to obtain at least one reflectivity image of said object, and
(c) a mapping mechanism operative to map at least a portion of a said reflectivity image to at least a portion of said geometric model so as to provide a reflectivity model of at least a portion of said object.

2. The system of claim 1, wherein said imaging mechanism is operative to obtain a plurality of said images taken from a plurality of perspectives.

3. The system of claim 2, wherein said perspectives include angles disposed about an axis.

4. The system of claim 3, further comprising:
(d) a holder operative to hold and rotate said object,
and wherein said perspectives are obtained by rotation of said object by said holder.

5. The system of claim 4, wherein said holder includes a vacuum mechanism operative to secure said object to said holder.

6. The system of claim 1, wherein said object includes a diffusing coating.

7. The system of claim 1, wherein said object includes at least one mark.

8. The system of claim 1, wherein said object includes a gemstone.

9. The system of claim 1, wherein said object includes a component selected from the group consisting of a diamond, an emerald and a ruby.

10. The system of claim 1, further comprising:
(d) an enclosure operative to isolate at least one component of the modeling system, selected from the group consisting of said modeling mechanism and said imaging mechanism, from stray light.

11. The system of claim 1, wherein said modeling mechanism includes a camera.

12. The system of claim 11, wherein said camera includes a digital camera.

13. The system of claim 1, wherein said modeling mechanism includes a source of structured light.

14. The system of claim 13, wherein said source of structured light is operative to produce a beam having a substantially linear cross-section.

15. The system of claim 13, wherein said source of structured light includes a laser.

16. The system of claim 1, wherein said modeling mechanism is operative to create said geometric model from a plurality of boundaries of said object, said boundaries being obtained from a plurality of images of said object.

17. The system of claim 16, wherein at least one said image from which a corresponding said boundary is obtained is a silhouette image of said object.

18. The system of claim 16, wherein at least one said image from which a corresponding said boundary is obtained is a reflectivity image of said object.

19. The system of claim 1, wherein said imaging mechanism includes a camera.

20. The system of claim 19, wherein said camera includes a digital camera.

21. The system of claim 1, wherein said imaging system includes a light source.

22. The system of claim 21, wherein said light source includes a light-emitting element selected from the group consisting of a light-emitting diode, a discharge lamp, a fluorescent lamp, an electroluminescent light, a laser and an incandescent lamp.

23. The system of claim 1, wherein said geometric model includes information from a structured-light image and information from an image selected from the group consisting of a reflectivity image and a silhouette image.

24. The system of claim 1, wherein said geometric model includes a three-dimensional finite-element model.

25. The system of claim 1, further comprising:
(d) a display device operative to show reflectivity of at least a portion of a surface of said object.

26. The system of claim 1, wherein said reflectivity model includes reflectivity information selected from the group consisting of grayscale information, color information, and enhanced color information.

27. The system of claim 1, wherein the modeling system is operative to rotate said reflectivity model through an arbitrary angle about an arbitrary axis.

28. A modeling method comprising the steps of:
(a) obtaining a geometric model of at least a portion of a surface of an object;
(b) obtaining at least one reflectivity image of said object, and
(c) combining said geometric model and reflectivity data from said reflectivity image to obtain a reflectivity model of at least a portion of said object.

29. The method of claim 28, wherein a plurality of said reflectivity images is obtained from a plurality of perspectives.

30. The method of claim 29, further comprising the step of:
(d) rotating said object to obtain said plurality of perspectives.

31. The method of claim 28, further comprising the step of:
(d) applying a diffusing coating to said object.

32. The method of claim 28, further comprising the step of:
(d) marking said object.

33. The method of claim 28, wherein said object includes a gemstone.

34. The method of claim 28, wherein said object includes a component selected from the group consisting of a diamond, an emerald and a ruby.

35. The method of claim 28, wherein said modeling is effected by steps including illuminating said object with structured light.

36. The method of claim 35, wherein said structured light includes a beam having a substantially linear cross-section.

37. The method of claim 28, wherein said obtaining of said geometric model includes:
(i) obtaining images of said object from at least two perspectives;
(ii) extracting boundaries from said images, and
(iii) creating said geometric model from said boundaries.

38. The method of claim 37, wherein at least one said image is a silhouette image of said object.

39. The method of claim 37, wherein at least one said image is a reflectivity image of said object.

40. The method of claim 28, further comprising the step of:
(d) illuminating said object with a light source selected from the group consisting of a light emitting diode, a discharge lamp, a fluorescent lamp, an electroluminescent light, a laser and an incandescent lamp.

41. The method of claim 28, wherein said obtaining of said geometric model includes obtaining at least one structured-light image of said object and at least one image, of said object, selected from the group consisting of a reflectivity image and a silhouette image, said geometric model being based on said images.

42. The method of claim 28, wherein said geometric model includes a three-dimensional finite-element model.

43. The method of claim 28, further comprising the step of:
(d) displaying reflectivity of at least a portion of a surface of said object.

44. The method of claim 28, wherein said reflectivity model includes reflectivity information selected from the group consisting of grayscale information, color information, and enhanced color information.

45. The method of claim 28, further comprising the step of:
(d) rotating said reflectivity model through an arbitrary angle about an arbitrary axis.

46. A machine readable storage medium having stored thereon machine executable instructions, the execution of said machine executable instructions implementing a method for modeling, the method comprising the steps of:
(a) obtaining a geometric model of at least a portion of a surface of an object;
(b) obtaining at least one reflectivity image of said object, and
(c) combining said geometric model and reflectivity data from said reflectivity image to obtain a reflectivity model of at least a portion of said object.

47. The machine readable storage medium of claim 46, wherein said object includes a gemstone.

48. The machine readable storage medium of claim 46, wherein said object includes a component selected from the group consisting of a diamond, an emerald and a ruby.
